(19) United States
(12) Patent Application Publication
(10) Pub. No.: US 2013/0116021 A1
(43) Pub. Date: May 9, 2013

(54) GAMES SIMULATOR

(71) Applicant: Alexay Borisovich Lukyanov, Jaroslavl (RU)

(72) Inventor: Alexay Borisovich Lukyanov, Jaroslavl (RU)

(73) Assignee: OOO "PARITÄT-ZENTR", g. Yaroslavl (RU)

(21) Appl. No.: 13/641,635

(22) PCT Filed: Apr. 15, 2011
(86) PCT No.: PCT/IB2011/000835

§ 371 Date: Oct. 16, 2012

(30) Foreign Application Priority Data
Apr. 16, 2010 (RU) 2010115319/12

(51) Int. Cl. A63F 13/06

(52) U.S. Cl. CPC A63F 13/06
USPC 463/6; 463/38

(57) ABSTRACT

The invention relates to a games simulator having a user control element, a monitor, a computer, and a vibration mechanism that are connected to the monitor. In order for the user to receive information about a vehicle's speed of motion without having to employ any visual elements, a computer is provided with a controller (control unit), which is connected to the vibration mechanism of the device for controlling characteristic data of a the vehicle's virtual motion, and the vibration mechanism is embodied, for instance, in the form of a wristband.

### CROSS-REFERENCE TO RELATED APPLICATION

This application claims the benefit of the priority filing date in PCT/IB2011/000835 and referenced in WIPO Publication No. WO2011/128768. The earliest priority date claimed is Apr. 16, 2010.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to a games simulator as defined by the preamble to claim 1.

The invention relates to entertainment devices, specifically computer- supported game simulators (simulation game devices). These simulators lend the illusion of motion, including the illusion of driving and the illusion of weight increase in a flight.

From the prior art, a race simulator is known. It includes a screen and a beamer, a capsule for the player, and a computer. The beamer is set up facing the screen at a fixed distance from it. A capsule for the player is provided with a simulation unit for simulating capsule control devices. The capsule is secured to a hydraulically controllable platform. The platform and the control unit are connected to the hydraulic station via ingoing and outgoing lines. The computer is connected to the capsule control device's simulation unit output via an input adaptor and to the control unit's input via an output adapter. The simulator additionally includes a vertical, cabinet-like stand. The hydraulic system and the control unit are built into the lower part of the stand. A beamer is disposed on the upper covering of the stand, and specifically on an additional hydraulically controlled platform. The platform is connected to the input and output channels of the control unit, and the screen is secured to a separate vertical stand. The stand is provided with a drive for adjusting its height. The height adjustment drive is computer-supported and is designed to be controllable via the output adaptor unit (Russian Design Patent RU 51775).

From the prior art, a training device that can be used for entertainment purposes, or in other words, as a games simulator, is also known. It includes user control elements, a control unit, a display unit for displaying the surroundings, and adjusters. The device is additionally equipped with a control device. The control device is coupled with adjusters. The adjusters are in turn connected to the body of the person by means of an element. This element acts directly on the body (Russian Design Patent RU 90604).

A steering wheel, the Trust Vibration Feedback Steering Wheel PC-PS2-PS-3 GM-3400, is also known, which includes user control elements in the form of a steering wheel and footpedals and is connected to a computer that has a screen. This device reinforces the vibration feedback effect. As a result, the vibration mechanism built into the steering wheel achieves a realistic perception of driving in various travel simulators. During the game, the feedback effect simulates the perception of bumpy places on the road, vibrations when cornering, and collisions and breakdowns.

All in all, in its essential features the Trust Vibration Feedback Steering Wheel PC-PS2-PS-3 GM-3400 is the closest to the invention of the present patent application and is considered to be its prototype.

The drawback of these known devices is the lack of feedback between the control unit (the computer) and the user. Feedback can lend the user helpful information, in addition to the displays, about the built-in mass-produced devices (monitor or “virtual reality mask”) for reproducing the environment. The additional information also includes vehicle limit or near-limit virtual motion parameters that appears on the monitor.

It is the object of the invention to develop a games simulator in which the user receives information about motion speed without having to use any visual elements. Thus, the user's attention is not distracted, and he can easily perform other actions. Furthermore, the loads exerted on the the virtual vehicle's user control elements are intended to be simulated (reproducing the perceptions of bumpy roads, and so forth). The game simulator of the present application is intended to be embodied as an additional device for displaying (monitoring) the speed of a virtual vehicle.

This object is attained by means of the features of claim 1.

According to the invention, this is attained in that the user is supplied with an additional means (which is not a user control element, like the steering wheel of the prototype) for displaying and monitoring vehicle speed parameters during the game. If the virtual speed is exceeded, control is exerted by means of a physical (not visual) effect on the user.

### SUMMARY

A games simulator including: (a) a monitor with a computer, which is connected to the user control element (joystick), and (b) a controller (control unit), which is connected to a vibration mechanism of a device for controlling the speed parameters of the vehicle.

The controller (control unit) is not a mass-produced unit in the computer. It is a microcomputer (computer processor, microchip, memory, buses, etc.) that has a program for ensuring communication between the computer and the game simulator. The control (control unit) provides for an adjuster to receive characteristic control data from an interface program and ensures calculation of the physical effect on the vibration mechanism and the control of the vibration mechanism.

The interface program ensures the following: (a) reception of the virtual vehicle's speed data from the simulator software; (b) an interface with the user; (c) calculation of control parameters by means of the vibration mechanism based on the data received; and (d) transmission of the control parameters to the controller by means of the vibration mechanism.

One example of something that can serve as the vibration mechanism is a wristband which is worn on the arm (or other body parts) of the user. The wristband is provided with a built-in electromechanical vibration element. The wristband can also be secured to user control elements (joysticks) or to components of an armchair, for instance, in such a way that the vibrations are readily received.

In a driver program of the simulator, the user specifies the desired characteristic data, such as the degree and type (nature) of effect, the relationships between frequency and speed of the object in the simulator, the values of the critical parameters and their respective frequencies, and other characteristic data. These characteristic data and values for an object's speed enter the controller (control unit). On the basis of these data, the controller calculates the effects and controls the electromechanical vibration element of the wristband. For example, the higher the “speed” of the vehicle, the higher the vibration frequency of the wristband when these vibrations are transmitted, for instance, to the skin of the user's arm or leg. The user is thus given information about those virtual motion parameters of the vehicle that have been exceeded to let him know that the situation is critical.

### DRAWINGS

The invention will be described in further detail in terms of exemplary embodiments shown in the drawings. In the drawings:

FIGS. 1 and 2 show the makeup of a games simulator, with a wristband that is secured to the user's body, and

FIGS. 3 and 4 show a setup of the games simulator, with a wristband that is secured to a user control element or to some component of an armchair, primarily on the armrest.

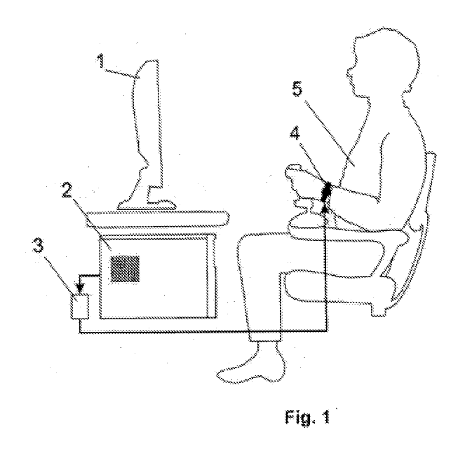

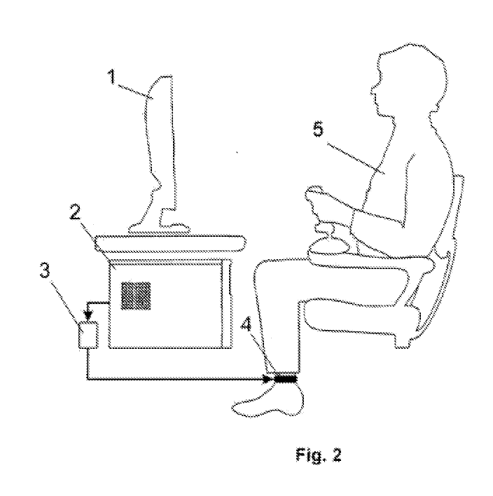

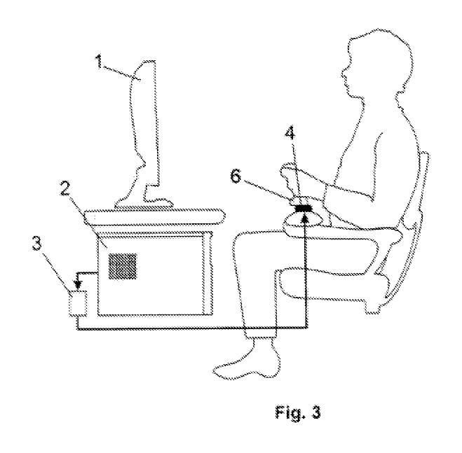

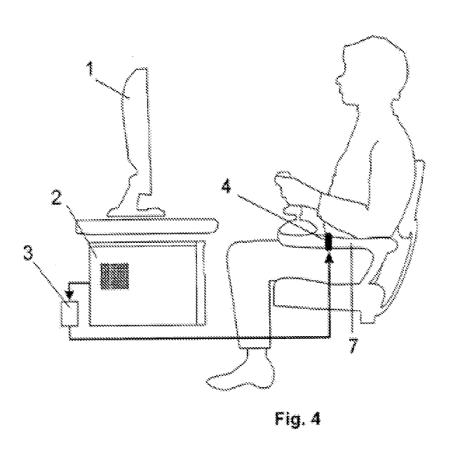

### DETAILED DESCRIPTION OF THE DRAWINGS

The games simulator has a monitor 1 and a computer 2, which via a controller (control unit) 3 communicates with an electromechanical vibration element of a wristband 4. The wristband 4 is secured to the user's body 5, predominantly to his arm or leg. The wristband 4 can also be secured to a user control element (joystick) 6 or to some part of the armchair 7, predominantly on the armrest.

The mode of operation of the games simulator is as follows:

In a driver program, the user specifies the characteristic data about the virtual motion of the vehicle. Next, the user starts the game, using the connected and installed wristband 4. In doing so, the image that simulates the motion is controlled by the user with the aid of the joystick. If, at any time, the user loses control of the control system, so that the specified characteristic data are exceeded, then the controller 3 (control unit) acts on the electromechanical vibration element of the wristband 4. The vibration element transmits the vibrations to the skin of the arm or leg, to the joystick 6, or the armrest of the user's armchair 7, and warns him of the dangerous situation. If the specifications are exceeded, then a higher vibration frequency is transmitted by the controller 3 to the wristband 4.

What is claimed:

1. A game simulator having a user control element (6), a monitor (1) a computer, (2) and a vibration mechanism (4) that are connected to the monitor, wherein, the computer (2) is provided with a controller (3), which is connected to the vibration mechanism (4) of the device for controlling characteristic data of a vehicle's virtual motion, and the vibration mechanism (4) is embodied in the form of a wristband.

2. The games simulator according to claim 1, wherein, the wristband (4) is provided with an electromechanical vibration element.

3. The games simulator according to claim 2, wherein, the wristband (4) is secured to the body (5) of the user.

4. The games simulator according to claim 2, wherein, the wristband (4) is secured to the user control element (6).

5. The games simulator according to claim 2, wherein, the wristband (4) is secured to an armchair (7).

6. The game simulator according to claim 1, wherein,
the user specifies the characteristic data of a vehicle's virtual advertising in a driver program;
the user begins the game with the wristband (4) connected and installed, and an image simulating motion is controlled with the aid of a joystick; and
if predetermined characteristic data are exceeded, the controller (3) acts on the electromechanical vibration element of the wristband (4).

7. The games simulator according to claim 6, wherein, if the specifications are exceeded, the controller (3) transmits a higher frequency to the wristband (4).
